(19) United States
(12) Patent Application Publication
(10) Pub. No.: US 2001/0021883 A1
(43) Pub. Date: Sep. 13, 2001

(54) L factor method for determining heat rate and emission rates of a fossil-fired system

(76) Inventor: Fred D. Lang, San Rafael, CA (US)

Correspondence Address: GARY HOENIG, HOENIG & ASSOCIATES, 2777 YULUPA AVE 222, SANTA ROSA, CA, 95405, US

(21) Appl. No.: 09/759,061

(22) Filed: Jan. 11, 2001

Related U.S. Application Data
(63) Continuation-in-part of application No. 09/273,711, filed on Mar. 22, 1999.
Application No. 09/273,711 is a continuation-in-part of application No. 09/047,198, filed on Mar. 24, 1998, now abandoned.

(51) Int. Cl. F02D 28/00

(52) U.S. Cl. 700/274

(57) ABSTRACT

The operation of a fossil-fueled thermal system is quantified by obtaining effluent flow, the L Factor and other operating parameters to determine and monitor the unit's heat rate and to determine the emission rates of its pollutants.

This application is a Continuation-In-Part of U.S. patent application Ser. No. 09/273,711 filed Mar. 22, 1999, for which priority is claimed and whose disclosure is hereby incorporated by reference in its entirety, application Ser. No. 09/273,711 is in turn a Continuation-In-Part of U.S. patent application Ser. No. 09/047,198 filed Mar. 24, 1998, for which priority is claimed and whose disclosure is hereby incorporated by reference in its entirety.

This invention relates to a fossil-fired power plant or steam generation thermal system, and, more particularly, to a method for determining its heat rate from the total effluents flow, the L Factor and other operating parameters. It also teaches how the EPA's F Factor may be properly used to monitor heat rate with certain precautions. It further teaches how the L Factor may be used to determine the system's emission rates of pollutants from fossil combustion with higher accuracy than afforded from the EPA's F Factor method.

### BACKGROUND OF THE INCEPTION

The importance of determining a system's thermal efficiency (also termed unit heat rate) of a fossil-fired power plant or steam generation system is critical if practical day-to-day improvements in thermal efficiency or heat rate are to be made, and/or problems in thermally degraded equipment are to be found and corrected. Although elaborate analytical tools are sometimes needed, simpler and less expensive methods are also applicable which do not require high maintenance nor the input of complex operational system data, and, also, whose accuracy is not greatly compromised. The L Factor method addresses this need.

General background of this invention is discussed at length in application Ser. No. 09/273,711 (hereinafter denoted as '711), and in application Ser. No. 09/047,198 (hereinafter denoted as '198). In '711 the L Factor is termed the “fuel factor”.

As discussed in '711, related art to the present invention was developed by Roughton in 1980; see J. E. Roughton, “A Proposed On-Line Efficiency Method for Pulverized-Coal-Fired Boilers”, Journal of the Institute of Energy, Vol.20, March 1980, pages 20-24. His approach using the L Factor (termed M_{d}/I_{d} in his work) in developing boiler efficiency was to compute system losses such that η_{Boiler}=1.0 −Σ(System Losses). This is a version of the Heat Loss Method discussed in '711. The principle losses he considered were associated with dry total effluents (termed stack losses), effluent moisture loss and unburned carbon loss. Roughton's method produces boiler efficiency independent of any measured fuel flow and independent of any measured total effluents flow.

The only related art known to the inventor since '711 and '198 were filed has been the technical paper: S. S. Munukutla, “Heat Rate Monitoring Options for Coal-Fired Power Plants”, Proceedings of Heat Rate Improvement Conference, Baltimore, Md., sponsored by Electric Power Research Institute, September 1998. In this paper Munukutla explains 40 CFR Part 60, Appendix A, Method 19, and the use of its F Factor to determine heat rate. Munukutla makes no mention of correction factors, neither conceptual nor those associated with measurement error. He concludes “. . . that the heat rate, as determined by the F-factor method, is in error by at least 10-20%.” In his “Conclusions” section, Munukutla states that: “The F Factor method may give accurate results, provided the stack gas flow rate and CO₂ concentration can be measured accurately.” He makes no mention of the molecular weight, or assumed composition, of the total effluents from combustion. Further, Munukutla explicitly states in his writing and by equation that system heat rate is inversely proportional to the concentration of effluent CO₂.

Related art to the present invention is the EPA's F Factor method, discussed in '711, and whose procedures are specified in Chapter 40 of the Code of Federal Regulations (40 CFR), Part 60, Appendix A, Method 19. Assumed by Method 19 is that an F_{c} Factor is the ratio of a gas volume found in the products of combustion (i.e., CO₂) to the heat content of the fuel.

### SUMMARY OF THE INVENTION

The monitoring of a fossil-fired system may involve detailed and complete descriptive understanding of the fuel being burned, analyses of all major components, and accurate determination of its fuel flow. Such monitoring is possible by applying the Input/Loss Method discussed in '711 and '198. However, for many fossil-fired systems simpler methods are needed which allow the installation of analytical tools which provide an inexpensive, but consistent, indication of a system's thermal performance. From such indication, the system's efficiency may be monitored, deviations found, and corrections implemented.

This invention discloses such a tool. Its accuracy is not at the level of the Input/Loss Method, but has been found to be within 1% to 2% when monitoring on-line, and, as importantly, has been demonstrate to be consistent.

This invention employs an L Factor to determine unit heat rate. A heat rate may also be computed using the EPA's F Factor, but with additional error relative to the L Factor, but which may be tolerable. The L Factor and the F Factor may be used to determine heat rate only if certain correction factors are applied as taught by this invention. These correction factors are both conceptual and for routine measurement error.

The present invention, termed the L Factor Method, determines total fuel energy flow of a fossil-fired system resulting, when the total fuel energy flow is divided by the measured system electrical output, the heat rate of the system results. Acceptable heat rate accuracy is achievable through the demonstrated high consistency found in the L Factor, to which this invention makes unique advantage.

The L Factor method does not use any part of the Heat Loss Method, it does not compute nor need any thermal loss term as used by Roughton. Unlike Roughton's method, the L Factor method employs certain major flows associated with a fossil-fired system, and principally the total effluents flow.

This invention is unlike Munukutla's work in several key areas. First, as taught by this invention, system heat rate using the F Factor is directly proportional to the concentration of effluent CO₂, not inversely proportional as Munukutla believes. Further, it has occurred during the development of this invention that certain conceptual correction factors must be applied to the L Factor to adequately monitor a fossil-fired system. No corrections of any kind are mentioned by Munukutla. This is significant to this invention for the F Factor affords one method of computing the L Factor (there is another which is preferred), however the sensitivities of the conceptual corrections which have been found to apply to the L Factor, also fundamentally apply to the F Factor. And lastly, Munukutla makes no mention of the molecular weight, or assumed composition, of the total effluents being produced which this invention teaches must be addressed as different fossil fuels produce different mixes of combustion products comprising the total effluents.

In the process leading to the present invention, several problems existing with the F Factor concept, which is used by Munukutla, have been both clarified and solutions found. These problems include the following: 1) large conventionally fired power plants have air in-leakage which alters the total effluents concentration's average molecular weight from base assumptions; 2) different Ranks of coal will produce different effluent concentrations thus different average molecular weights from base assumptions; 3) circulating fluidized bed boilers are injected with limestone to control SO₂, limestone produces CO₂ not addressed by the F_{c} Factor; 4) many poor quality coals found in eastern Europe and from the Powder River Basin in the United States may have significant natural limestone in its fuel's mineral matter, thus producing effluent CO₂ not addressed by the F_{c} Factor; 5) the EPA requires the reporting of emission rates based on measured wet volumetric flow reduced to standard conditions, but the quantity of effluent moisture is not independently measured, whose specific volume varies greatly as a function of its molar fraction thus introducing a major source of error in using volumetric flow; and 6) ideal gas behavior is assumed.

### BRIEF DESCRIPTION OF THE DRAWING

FIG. 1 is a block diagram illustrating the procedures involved in determining unit heat rate using the L Factor.

### DESCRIPTION OF THE PREFERRED EMBODIMENT

The L Factor

This invention expands '711 by using its L′_{Fuel} quantity (or its equivalence the L_{Fuel} quantity), herein termed the L Factor, also known in '711 as the “fuel factor”, to compute a thermal system's unit heat rate. L′_{Fuel} is defined by Eq.(72) of '711, repeated here with one change:

L′_{Fuel}=[x_{Dry-theor} N_{Dry-Fuel}+a_{Dry-theor}(1+φ_{Ref})N_{Dry-Air}−JₜₕₑₒᵣN_{H2O}−x_{MAF-theor}α_{MAF-10}N_{Ash}]/(x_{Dry-theor}N_{DryFuel}HHV_{Dry}) (72A)

The difference is the term (Ref which was changed from φ_{Act}. This invention teaches that φ_{Ref} must be employed since changes in combustion air's oxygen content should not effect L Factor. The preferred embodiment is to set φ_{Ref}=3.773725, with a range given as: 3.76≦φ_{Ref}≦3.79 [i.e., 0.2088≧A_{Ref}≧0.2100, where φ_{Ref}=(1−A_{Ref})/A_{Ref}] as effects the determination of the L Factor. The equivalence of L′_{Fuel} is L_{Fuel}, and is defined in words between Eqs.(75) and (76) in '711. When the quantities x, a and J of '711 are in per cent, the calculational base is therefore 100 moles of dry gas, thus:

L_{Fuel}=100 x_{Dry-theor} N_{DryGas/theor}/(x_{Dry-theor} N_{Dry-Fuel} HHV_{Dry}) (75A)

As fully explained in '711, the numerators of the right sides of these two equations are developed from the same mass balance equation involving dry fuel and stoichiometrics associated with theoretical combustion (also called stoichiometric combustion):

[x_{Dry-theor} N_{Dry-Fuel}+a_{Dry-theor} (1+φ_{Ref})N_{Dry-Air}−Jₜₕₑₒᵣ N_{H2O}−x_{MAF-theor} α_{MAF-10} N_{Ash}]=100 x_{Dry-theor} N_{DryGas/theor} (80)

Eq.(80) states that dry fuel, plus theoretical combustion air, less effluent water, less effluent ash results in dry gaseous total effluents associated with theoretical combustion. Eq.(80) is the bases for the L Factor; i.e., when each side of Eq.(80) is divided by x_{Dry-theor}N_{Dry-Fuel}. This is fundamentally different than EPA's F Factor method. Although Eqs.(72A) & (75A) employ molar quantities, use of molecular weights results in a mass-base for the L Factor, and for Eq.(80). The molecular weight of the dry gas total effluents associated with theoretical combustion is the term N_{DryGas/theor} (the identical quantity is denoted as N_{Dry-Gas} in '711), its associated mass-base, or mass flow rate, is denoted as m_{DryGas/theor}. Units for the L Factor are pounds_{Dry-effluent}/million-Btu_{Fuel}, or its equivalence. The L Factor expresses the “emission rate” for dry gaseous total effluents from theoretical combustion of dried fuel.

For a coal fuel, having a unique Rank or uniquely mined, the L Factor has been shown to have a remarkable consistency to which this invention makes unique advantage when applied in determining heat rate. Standard deviations for coals range from 0.02% (for semi-anthracite), to 0.05% (for medium volatile bituminous), to 0.28% (for lignite B). Table 1 illustrates this, obtained from F. D. Lang, “Monitoring and Improving Coal-Fired Power Plants Using the Input/Loss Method—Part II”, ASME, 1999-IJPGC-Pwr-34, pp.373-382. Listed in the third and fourth columns are standard deviations, in engineering units. Table 1 also presents moisture-ash-free higher heating values and computed F_{c} Factors.

TABLE 1
L Factors and F_{C} Factors for Various Coal Ranks
(L_{Fuel} and F_{C} in units of lbm/million-Btu, HHV in Btu/lbm)

| | | Heating Value | L Factor | |
|---|---|---|---|---|
| | No. of | HHV_{MAF} ± | L_{Fuel} ± | Computed |
| Coal Rank | Samples | ΔHHV_{MAF} | ΔL_{Fuel} | F_{C} Factor |
| Athracite | 29 | 14780.52 ± | 827.55 ± | 2035 |
| (an) | | 262.65 | 1.62 | |
| Semi-Anthracite | 16 | 15193.19 ± | 804.10 ± | 1916 |
| (sa) | | 227.41 | 0.19 | |
| Low Vol. Bituminous | 89 | 15394.59 ± | 792.82 ± | 1838 |
| (lvb) | | 435.54 | 0.39 | |
| Med. Vol. Bituminous | 84 | 15409.96 ± | 786.60 ± | 1593 |
| (mvb) | | 491.21 | 0.41 | |
| High Vol. A Bit. | 317 | 15022.19 ± | 781.93 ± | 1774 |
| (hvAb) | | 293.35 | 0.98 | |
| High Vol. B Bit. | 152 | 14356.54 ± | 783.08 ± | 1773 |
| (hvBb) | | 304.65 | 1.58 | |
| High Vol. C Bit. | 189 | 13779.54 ± | 784.58 ± | 1797 |
| (hvCb) | | 437.67 | 1.55 | |
| Sub-Bituminous A | 35 | 13121.83 ± | 788.25 ± | 1867 |
| (subA) | | 355.55 | 1.07 | |
| Sub-Bituminous B | 56 | 12760.63 ± | 787.07 ± | 1862 |
| (subB) | | 628.26 | 1.13 | |
| Sub-Bituminous C | 53 | 12463.84 ± | 788.67 ± | 1858 |
| (subC) | | 628.26 | 3.07 | |
| Lignite A | 76 | 12052.33 ± | 796.52 ± | 1905 |
| (ligA) | | 414.79 | 1.53 | |
| Lignite B | 25 | 10085.02 ± | 765.97 ± | 1796 |
| (ligB) | | 180.09 | 2.11 | |

This paragraph discusses several definitions which are useful in understanding this invention. First, As-Fired fuel energy flow is numerically is the same as dry fuel energy flow if based on either actual combustion or theoretical combustion: m_{As-Fired}HHV=m_{DryFuel/Act}HHV_{Dry}, or m_{As-Fired/theor}HHV=m_{DryFuel/theor}HHV_{Dry}. However, the dry fuel energy flow based on actual combustion is not the same as dry fuel energy flow based on theoretical combustion implied in Eqs.(72A) & (75A): m_{DryFuel/Act} HHV_{Dry}≠m_{DryFuel/theor} HHV_{Dry}. Second, the US Environmental Protection Agency (EPA) requires the measurement of the actual total effluents flow from most thermal systems, discussed in '711. Although reported for the EPA as a volumetric flow at standard conditions, this invention teaches to convert to a mass-base using the hot densities (not cold), involving both gas and moisture. This is not the same total effluents mass flow associated with theoretical combustion, termed m_{DryGas/theor}. This invention also teaches the elimination of the total effluents. Third, the conversion from any efficiency (η)) to a heat rate (HR) is common art, for example: HR_{turbine-cycle}=3412.1416/η_{turbine-cycle} where the constant converts units from Btu/hr to kilowatts, thus HR carries the units of Btu/kW-hr. Fourth, the following equality is important when determining the L Factor: x_{Dry-theor} N_{DryFuel} HHV_{Dry}=x_{Wet-theor} N_{Wet-Fuel} HHV.

This invention teaches that first correcting L_{Fuel} from conditions associated with theoretical combustion to actual conditions, and then dividing the corrected L_{Fuel} into the measured total effluents mass flow rate, the total (i.e., “As-Fired”) fuel energy flow, m_{As-Fired} (HHVP+HBC), is derived:

m_{As-Fired} (HHVP+HBC)=10⁶ Ξ_{Gas} m_{DryGas/Act}[L_{Fuel} Ξ_{AF}] (81)

where the units of mass flow (m) are lbm/hr, corrected heating value (HHVP) and Firing Correction (BBC) in Btu/lbm, and the L Factor in lbm/million-Btu. Ξ_{Gas} and Ξ_{AF} are discussed below.

From Eq.(8 1) As-Fired fuel mass flow may then be determined if heating value and the Firing Correction have been determined:

m_{As-Fired}=10⁶ Ξ_{Gas} m_{DryGas/Act}/[L_{FueI} Ξ_{AF} (HHVP+HBC)] (82)

As is common art for an electric power plant, dividing m_{As-Fired} (HHVP+HBC) by the total useful output, denoted as P in kilowatts, see '711 Eq.(1), unit heat rate is then determined.

HRᵤₙᵢₜ=10⁶ Ξ_{Gas} m_{DryGas/Act}[L_{Fuel} Ξ_{AF} P] (83)

'711 teaches the determination and use of HHVP and HBC. Alternatively, for situations where heating value may be reasonably estimated the methods of '711 developing HHVP need not apply. Further, the HBC term could be assumed to have negligible effect and thus taken as zero, computed using '711 procedures, or estimated and/or held constant. HBC and HHVP are included here to illustrate consistency with '711 and '198. The L_{Fuel} parameter is typically based on an uncorrected heating value, HHV, thus requiring the HHV/(HHVP+HBC) correction within the Ξ_{AF} term, see Eq.(84). The corrected heating value, HHVP, could be used to develop L_{Fuel}, but is not preferred.

In Eqs.(81), (82) & (83), Ξ_{Gas} is a correction factor for measurement error in the total effluents flow. As a defined thermodynamic factor addressing conceptual corrections, Ξ_{AF} of Eq.(84) principally converts conditions associated with theoretical combustion to those associated with the actual (As-Fired) conditions, thus allowing the use of the L Factor. The combined L_{Fuel}Ξ_{AF} expression is termed the corrected L Factor, that is, producing actual total effluents flow divided by the actual As-Fired fuel energy flow, and as normalized to the bases of efficiency used at a given facility. For example, if the power plant uses HHV, then the term HHV/(HHVP+HBC) would not appear in Eq.(84); if only HHVP is used then the term HHV/HHVP would appear. This is termed the correction for the system heating value base. Use of (HHVP+HBC) as a bases, thus Eq.(84) as presented, is preferred.

Ξ_{AF}=[m_{DryGas/Act} m_{WetFuel/theor}/(m_{DryGas/theor} m_{As-Fired})]HHV/(HHVP+HBC) (84)

Although L_{Fuel} is based on dry fuel energy flow associated with theoretical combustion, the ratio m_{DryFuel/theor}/m_{DryFuel/Act} is equivalent to the ratio m_{WetFuel/theor} /m_{As-Fired}, allowing Ξ_{AF} of Eq.(84) to correct the denominator of L_{Fuel} such that its bases is the As-Fired (actual, wet) fuel conditions.

When the total effluents flow is measured on a wet-base, m_{WetGas/Act}, L_{Fuel} is further corrected with the term (1−WF_{H2O}), where WF_{H2O} is the weight fraction of moisture determined to be in the wet total effluents. The factor (1−WF_{H2O}) converts the L_{Fuel}'s numerator from a dry-base to a wet-base expression of the total effluents mass. The preferred embodiment is to use a dry-base total effluents which involves less uncertainty given possible inaccuracies in determining WF_{H2O}. However, F_{H2O} may be determined by measurement of the volume (molar) concentration of effluent moisture and converting to a mass-base, or through computer simulation of the system, estimated, or other means. As applied: Ξ_{AF/Wet}=Ξ_{AF}/(1−WF_{H2O}), the corrected L Factor then being the quantity L_{Fuel} Ξ_{AF/Wet}. This correction is termed conversion to a wet-base L Factor.

'711 teaches that turbine cycle energy flow (BBTC in Btu/hr) may be used to compute As-Fired fuel flow, via its Eq.(2 1). However, this may also be used to overcheck Eq.(82)'s fuel flow, or Eq.(81)'s fuel energy flow, given a determined boiler efficiency.

m′_{As-Fired}=BBTC _{TC} /[η_{Boiler} (HHVP+HBC)] (85A)

m′_{As-Fired} (HHVP+HBC)=BBTC Ξ_{TC}/[η_{Boiler}] (85B)

Boiler efficiency may be determined by: 1) estimation by the power plant engineer; 2) methods of '711; 3) held constant; 4) determined using the methods of the American Society of Mechanical Engineers (ASME), Performance Test Codes 4.1 or 4; 5) the methods described in the technical paper: F. D. Lang, “Monitoring and Improving Coal-Fired Power Plants Using the Input/Loss Method—Part III”, ASME, 2000-IJPGC-15079(CD), July 2000; and/or 6) the methods described in the technical paper: E. Levy, et al., “Output/Loss: A New Method for Measuring Unit Heat Rate”, ASME, 87-JPGC-PWR-39, October 1987.

The term Ξ_{TC} of Eq.(85A) is a factor chosen such that the computed fuel flow from Eq.(85A), m′_{As-Fired}, and that of Eq.(82) have reasonable agreement. An alternative approach is to choose Ξ_{TC} of Eq.(85B) such that the computed fuel energy flow, m′_{As-Fired} (HHVP+HBC), and that of Eq.(81) have reasonable agreement. For the typical power plant situation, the greatest uncertainty in determining fuel flow (or fuel energy flow) using Eq.(85), or Eq.(21) of '711, lies with the turbine cycle energy flow, BBTC; provided HHVP (or HHV) is known. Thus the factor Ξ_{TC} is used to adjust and correct the BBTC quality until fuel flow, and/or fuel energy flow, from the two methods have reasonable agreement. Broadly, Ξ_{TC} is a general correction to the turbine cycle energy flow; however errors in boiler efficiency and/or heating value are also addressed. The advantage of this technique lies in its foundation with the demonstrated consistency of the L Factor. With adjustments through Ξ_{TC}, the turbine cycle heat rate may be determined:

HR_{turbine-cycle}=BBTC Ξ_{TC}/P (86)

The L Factor method may be further extended to eliminate the requirement to measure total effluents flow, replaced with a fuel flow measurement. This may be accomplished by simplification of Ξ_{AF} to the following given cancellation of the m_{DryGas/Act} term; see Eqs.(83) & (84):

Ξ_{FG}=[m_{WetFuel/theor}/ m_{DryGas/theor}]HHV/(HHVP+HBC) (87)

Thus:

m_{As-Fired}(HHVP+HBC)=10⁶ Ξ_{Fuel} m_{AF/On-L}/[L_{Fuel} Ξ_{FG}] (88)

m_{As-Fired}=10⁶ Ξ_{Fuel} m_{AF/On-L}/[L_{Fuel} Ξ_{FG}(HHVP+HBC)] (89)

HRᵤₙᵢₜ=10⁶ Ξ_{Fuel} m_{AF/On-L}/[L_{Fuel} Ξ_{FG} P] (90)

where the quantity Ξ_{FG} may be computed explicitly knowing only the fuel chemistry and assuming theoretical combustion. In Eqs.(88), (89) & (90), Ξ_{Fuel} is a correction factor for measurement error in the unit's indicated As-Fired fuel flow measurement, termed m_{AF/On-L}. The advantage of using Ξ_{FG}, and Eqs.(88), (89) & (90), lies when the fuel flow measurement, although typically not accurate in coal-fired plants, is a consistent measurement, thus correctable through Ξ_{Fuel}. Further, the Ξ_{FG} quantity is constant for a given fuel, and easily calculated. Although Eq.(90) reduces to [m_{As-Fired/Act} (HHVP+HBC)/P], the classical definition of HRᵤₙᵢₜ, it is composed of quantities which could be measured on-line if having the necessary consistently (in the m_{AF/on-L} and P terms). It also has usefulness to check the measured total effluents flow by equating Eqs.(81) and (88) and solving for m_{DryGas/Act}, Eq.(90) has applicability for fuels with highly variable water and ash contents, but where L_{Fuel} is constant (as has been demonstrated in Table 1, e.g., lignite fuels). Eq.(89) may also be used for checking the indicated fuel flow, or fuel energy flow via Eq.(88), with the tested or observed quantity.

Additionally, this invention is not limited by the above presentation. Heating value could be computed using Eqs.(81) and (85A), or Eq.(88), provided fuel flow is independently determined. The preferred embodiment of this invention is to use the L Factor, and when off-line, Eqs.(81), (82) & (83).

The F Factor

The following discusses the EPA's F Factor in light of its use in determining the L Factor. Using the F_{c} Factor, if effluent CO₂ is measured on a dry base, the emission rate for the dry gaseous total effluents is given by Eq.(91), which is an alternative method for computing the L Factor. A validity test for use of the F_{c} Factor lies in whether Eq.(91) produces constant values; at least as consistent as observed with actual data, and especially for coal data (see Table 1). The L Factor as computed from the F_{c} Factor is herein termed L_{FuelEPA}. It is corrected with the Ξ_{AF} term defined by Eq.(84). The corrected L Factor is given as L_{FueI/EPA} Ξ_{AF}.

L_{Fuel/EPA}=100 N_{DryGas/Act} F_{c}/(385.321 d_{Act} Ξ_{AF}) (91)

N_{DryGas/Act} is the molecular weight of the actual dry gaseous total effluents (with system air in-leakage), and d_{Act} is the measured concentration of CO₂ at the system's boundary on a dry base (in per cent). Reference should be made to '198 and '711 for encompassing stoichiometrics. F_{c} may be determined: 1) by computation based on fuel chemistry using EPA procedures; 2) by using constant values as suggested by the EPA for certain fuels; or 3) by using values from Table 1. The bases for Eq.(91) is fully discussed in the technical paper: F. D. Lang and M. A. Bushey, “The Role of Valid Emission Rate Methods in Enforcement of the Clean Air Act”, Proceedings of Heat Rate Improvement Conference, Baltimore, Md., sponsored by Electric Power Research Institute, May 1994 (also published in: FLOWERS '94: Proceedings of the Florence World Energy Research Symposium, editor E. Carnevale, Servizi Grafici Editoriali, Padova, Italy 1994). Lang and Bushey used the symbol β_{CO2-dry} for d_{Act} (as used here and in '711), and E for emission rate whereas ER is used here and in '711. Also note that Lang and Bushey correct for the molecular weight of the gas actually being computed using the gas constant, assuming ideal gas behavior, leading to the conversion factor of 385.321 ft³/lb-mole at standard EPA conditions of 68F and 14.6959 psiA. F_{c} carries units of ft³-CO₂ /million-Btu, thus needed conversion from the volumetric.

It has been found that Eq.(91) may produce reasonable L Factors. However, when assuming a constant fuel chemistry, L_{Fuel/EPA} is not found dead constant (as with L_{Fuel}) when varying operational parameters (e.g., total effluents flow, excess O₂, etc.). EPA regulations rely on Eq.(91) and its underlying technology to describe the dry pounds of the total effluents per million-Btu of fuel burned, for actual conditions found at any stationary source of fossil combustion. This may be adequate for some situations, it is not preferred over the L_{Fuel} method and use of Eqs.(72A) or (75A).

This invention teaches by the very nature of the F_{c} formulation used by the EPA, errors must be realized when F_{c} is employed for actual systems. As found in the course of developing this invention, the definition of the L Factor must intrinsically involve effluent water and effluent ash, see Eq.(72A); F_{c} does not, it is a simple conversion of fuel to effluents using ideal assumptions, without consideration of basic combustion. Different fuels have different water and ash contents, and are subtracted from the fuel and combustion air terms of Eq.(72A), their presents and consideration is conceptually important. Although Eq.(91) uses the Ξ_{AF} term to correct, use of a constant F_{c}, derived without consideration of basic combustion, results in a slightly variable L Factor as demonstrated in Table 2.

In Table 2 the R_{Act} term is the air pre-heater “leakage factor” discussed in '711; the A_{Act} term is also defined and used throughout '711, yielding φ_{Act}=3.82195 for the example; by “boiler” is meant that the excess O₂ measurement is taken at the combustion gas inlet to the air pre-heater, before dilution by air pre-heater leakage. The last case studied varied the A_{Act} term, thus φ_{Act}, which would affect the mass of the dry total effluents although not the fuel per se. Table 2 clearly illustrates in its fourth column that L_{Fuel/EPA} varies for different combustion conditions, F_{c} being constant for the same fuel. The standard deviation in L_{Fuel} for hvAb coal, studying 317 samples is 0.13%. The range of L_{Fuel/EPA} implies, for the averaged hvAb coal (a constant fuel chemistry), a 100 ΔBtu/kW-hr heat rate change (or 1.2% error). This is a conceptual error, and although may not be serious for all situations, it may be significant for some fossil fueled systems whose fuel's heating value does not vary significantly.

TABLE 2
Typical Sensitivities of L_{Fuel} and L_{Fuel/EPA}
for High Volatile A Bituminous (hvAb) Coal

| | | Correction | L_{Fuel/EPA} |
|---|---|---|---|
| | L_{Fuel}, | Ξ_{AF}, | (F_{C} = 1774), |
| hvAb Case | Eq.(75A) | Eqs.(84) | Eq.(91) |
| Theoretical | 781.93 | 1.00000 | 773.81 |
| Combustion | | | |
| 1.0% excess O₂, | 781.93 | 1.04664 | 776.39 |
| R_{Act} = 1.00. | | | |
| 2.0% excess O₂, | 781.93 | 1.09820 | 778.99 |
| R_{Act} = 1.00. | | | |
| 3.0% excess O₂, | 781.93 | 1.15551 | 781.61 |
| R_{Act} = 1.00. | | | |
| 3.0% excess | 781.93 | 1.26410 | 781.89 |
| O₂ (boiler), | | | |
| and R_{Act} = 1.10 | | | |
| 3.0% excess | 781.93 | 1.27821 | 782.62 |
| O₂ (boiler), | | | |
| R_{Act} = 1.10, and | | | |
| A_{Act}, = 0.207385. | | | |

If F_{c} Factors are to be used to produce the L Factor, this invention teaches that Eq.(91) must be used with caution, and that applying numerical bias or a contrived correlation to the resulting heat rate must be considered.

The following equations apply for determining fuel flow and unit heat rate based on the F_{c} Factor, employing mass or volumetric flows.

m_{As-Fired}=385.321×10^{6 Ξ}_{Gas} m_{DryGas/Act} d_{Act}/ [100N_{DryGas/Act}F_{c} (HHVP+HBC)] (92A)

m_{As-Fired}=385.321×10⁶ Ξ_{Gas} m_{WetGas/Act} D_{Act/Wet}/[100N_{WetGas/Act}F_{c} (HHVP+HBC)] (92B)

m_{As-Fired}=1.0×10⁶ Ξ_{Gas} q_{DryGas/Act} d_{Act}/ [100 F_{c} (HHVP+HBC)] (92C)

m_{As-Fired}=1.0×10⁶ q_{WetGas/Act} d_{Act/Wet}/ [100 F_{c} (HHVP+HBC)] (92D)

HRᵤₙᵢₜ=385.321×10⁶ Ξ_{Gas} m_{DryGas/Act} d_{Act}/ [100 N_{DryGas/Act} F_{c} P] (93A)

HRᵤₙᵢₜ=385.321×10⁶ Ξ_{Gas} m_{WetGas/Act} d_{Act/Wet}/ [100 N_{WetGas/Act} F_{c} P] (93B)

HRᵤₙᵢₜ=1.0×10⁶ Ξ_{Gas} q_{DryGas/Act} d_{Act}/ [100 F_{c} P] (93C)

HRᵤₙᵢₜ=1.0×10⁶ Ξ_{Gas} q_{WetGas/Act} d_{Act/Wet}/ [100 F_{c} P] (93D)

where m_{DryGas/Act} or m_{WetGas/Act} are the dry-base or wet-base mass flow rates (lbm/hour) of total effluents, and q_{DryGas/Act} or q_{WetGas/Act} are the volumetric flow rates (ft³/hour). Multiplying both sides of Eq.(92) by (HHVP+HBC) produces total fuel energy flow as in Eq.(81). Eq.(93) states that heat rate is directly proportional to the total effluents flow and the CO₂ concentration, and inversely proportional to F_{c} and electrical power (kilowatts). These equations may be repeated using the F_{w} and F_{D} Factors, also described and allowed by 40 CFR Part 60, Appendix A, Method 19.

Although the correction MAF cancels from Eqs.(92) & (93), as discussed above the concept of F_{c} results in a lack the accuracy when compared to the L Factor; see typical results in Table 2. Without sensitivity to the terms comprising Ξ_{AF}, or Ξ_{AF/wet}, Eqs.(92) & (93) must rely on the single sensitivity of the concentration of CO₂, d_{Act} or d_{Act/Wet}, to account for the effects of changing total effluents and As-Fired fuel flow. This observation has lead to corrections associated with on-line monitoring using the F_{c} Factor.

On-Line Monitoring

The following presents a similar factor to Ξ_{AF}, termed Ξ_{On-L}, which is applied for on-line monitoring and may be determined from routine system operational data. Thus Ξ_{On-L} may be substituted for Ξ_{AF} to achieve on-line monitoring of heat rate. By on-line monitoring is meant the analysis of plant data using the methods of this invention in essentially real time, and/or simply the acquisition of plant data.

As taught, the L Factor requires corrections to the actual, from total effluents and fuel flows associated with theoretical combustion. The total effluents flow correction is developed by first dividing all terms of Eq.(80) by x_{Dry-theor}N_{Dry-Fuel}, thus developing an Air/Fuel ratio (termed AF_{Dry-theor}), and then substituting L_{Fuel} from Eq.(75A):

1.0+AF_{Dry-theor}−(JₜₕₑₒᵣN_{H2O}+x_{MAF-theor} α_{MAF-10} N_{Ash}) / (x_{Dry-theor} N_{Dry-Fuel})=L_{Fuel} HHV_{Dry} (94)

The terms in Eq.(94) involving effluent moisture and ash may be expressed as fuel weight fractions given theoretical combustion. However, since only the influence of dry total effluents on L_{Fuel} is desired it has been found that only the As-Fired weight fraction of ash needs to be considered in practice:

1.0+AF_{Dry-theor}−WF_{Ash}≈L_{Fuel} HHV_{Dry} (95)

or simplifying using a constant K₁ (=1.0−WF_{Ash}), descriptive of a given fuel:

−K₃AF_{Wet-theor}+K₁=L_{Fuel} HHV_{Dry} (96)

where K₃ is a conversion from dry-base to wet-base for theoretical combustion. L_{Fuel}HHV_{Dry} is approximately constant for any operation burning the same fuel; noting that the fuel's water content may vary as it commonly does with poorer quality coals. Thus the ratio of indicated system wet Air/Fuel ratio to the wet Air/Fuel ratio associated with theoretical combustion, addresses the correction for total effluents flow. The correction for fuel flow is addressed as the ratio of the system's indication of As-Fired fuel flow (m_{AF/On-L}) to the fuel flow associated with theoretical combustion (m_{WetFuel/theor}).

The following functionality has been found to yield good results while monitoring a system on-line, when the total effluents flow is being measured:

Ξ_{On-L}=[K₂ (AF_{Wet/On-L}+K₁)m_{AF/On-L}]HHV/(HHVP+HBC) (97)

It has been found in practice that the system engineer may determine K₁ and K₂ quickly by adjustments to his/her on-line monitoring routines, on-line monitoring software, or to the plant's data acquisition computer, or by estimation. To determine reasonable initial estimates: K₁ may be computed as taught above; K₂=1.0/[(K₃ AF_{Wet-theor}+K₁) m_{WetFuel/theor}] as based on theoretical combustion, and requiring adjustment for the type of flow being monitored either mass-base or volume-base (e.g., the conversion factor 385.321 ft³/lb-mole at standard conditions); and where K₃=1.0. Eq.(97) employs the system's on-line measurements of Air/Fuel ratio (AF_{Wet/On-L}), and the As-Fired fuel flow (m_{AF/On-L}). Eq.(97) could also be expressed in terms of the actual combustion air flow measurement, m_{Air-On-L}:

Ξ_{On-L}=[K₂ (m_{AF/On-L}+K₁ m_{AF/On-L})]HHV/ (HHVP+HBC) (98)

Finally, the methods of this invention may be applied on-line using the following equation. In Eq.(99) q_{DryGas/Act} is the measured dry total effluents volumetric flow, typically reported by system instruments in units of ft³/hour. If the total effluents flow is reported as a mass flow then Eqs.(81), (82) and (83), would apply replacing Ξ_{AF} with Ξ_{On-L}. The effluent density, termed p, must be consistent with the measurement base of the volumetric flow. The preferred embodiment, if using Eqs.(99) or (100), is the use of hot flows with hot densities.

HRᵤₙᵢₜ=10⁶ Ξ_{Gas} q_{DryGas/Act} ρ_{DryGas}/ [L_{Fuel} Ξ_{On-L} P] (99)

The combined L_{Fuel}Ξ_{On-L} expression is termed the corrected L Factor. For a total effluents volumetric flow measured on a wet-base, the following applies:

HRᵤₙᵢₜ=10⁶ Ξ_{Gas} q_{WetGas/Act} ρ_{WetGas} (1−WF_{H2O})/[L_{Fuel} Ξ_{On-L} P] (100)

Thus the L Factor may be corrected to a dry-base or wet-base, reflecting the nature of the total effluents considered.

To illustrate the accuracy of the L Factor method the following table presents results of using several of the procedures discussed. Its accuracy is considered exceptional.

TABLE 3
Typical Heat Rate Results for
High Volatile A Bituminous (hvAb) Coal
(using Ξ_{AF} from Table 2, and Ξ_{On-L} via Eq.(97))

| | Measured | L Factor | L Factor |
|---|---|---|---|
| | Unit | Heat Rate, | Heat Rate, |
| | Heat Rate | Off-Line | On-Line |
| hvAb Case | (Btu/kW-hr) | Eq.(83) | Eq.(99) |
| Theoretical | 8436 | 8436 | 8436 |
| Combustion | | | |
| 1.0% excess O₂, | 8452 | 8452 | 8455 |
| R_{Act} = 1.00. | | | |
| 2.0% excess O₂, | 8471 | 8469 | 8474 |
| R_{Act} = 1.00. | | | |
| 3.0% excess O₂, | 8491 | 8488 | 8483 |
| R_{Act} = 1.00. | | | |
| 3.0% excess | 8530 | 8526 | 8526 |
| O₂ (boiler), | | | |
| and R_{Act} = 1.10 | | | |
| 3.0% excess | 8535 | 8530 | 8529 |
| O₂ (boiler), | | | |
| R_{Act} = 1.10, and | | | |
| A_{Act} = 0.207385. | | | |

To apply the F_{c} Factor to the on-line monitoring of a power plant the following equations apply:

HRᵤₙᵢₜ=Ξ_{On-L/F} m_{DryGas/Act} d_{Act}/ [100 N_{DryGas/Act} F_{c} P] (101A)

HRᵤₙᵢₜ=Ξ_{On-L/F} q_{DryGas/Act} d_{Act}/ [100 F_{c} P] (101B)

or, for wet-base quantities:

HRᵤₙᵢₜ=Ξ_{On-L/F} m_{WetGas/Act} d_{Act/Wet}/ [100 N_{WetGas/Act} F_{c} P] (102A)

HRᵤₙᵢₜ=Ξ_{On-L/F} q_{WetGas/Act} d_{Act/Wet}/ [100 F_{c} P] (102B)

When on-line, the molecular weight of the total effluents, N_{WetGas/Act} or N_{DryGas/Act}, may be held constant or computed knowing the fuel's chemistry and operating parameters as was well discussed in '711 and '198; see Eq.(29) of '711. It has been found that the factor Ξ_{On-L/F}, suggested by the factor Ξ_{On-L} discussed above, may be resolved as follows:

Ξ_{On-L/F}=[K_{2F} (AF_{Wet/On-L}+K_{1F}) m_{AF/On-L}]HHV/ (HHVP+HBC) (103)

where the factors K_{2F} and K_{1F} are adjusted such that the system operator's observations and those produced from Eq.(101) or (102) have reasonable 10 agreement. The factor K_{1F} may be computed as taught for K₁, or otherwise determined; it generally may be held constant. The factor K_{2F} is typically estimated or otherwise determined, and may include functionalities related to moisture in the total effluents, As-Fired fuel moisture, addresses different flow measurements (volumetric- or mass-base), and/or a correlation which adjusts the Air/Fuel ratio using operational parameters. In practice, for a given thermal system, the factor K_{2F} is developed as a variable, having at least functionality with a measured moisture in the total effluents. The preferred embodiment of this invention is to use the L Factor, and when on-line, Eqs. (99) & (100).

Emission Rates of Pollutants

The ability to compute As-Fired fuel flow based on the L Factor, as taught by this invention, allows the determination of pollutant emission rates (ER) typically required for regulatory reporting. As taught in '711, and its Eq.(70B) and associated discussion, the emission rate of any effluent species may be determined by knowing its molar fraction (i.e., its concentration) within the total effluents, molecular weight of the species and the As-Fired fuel, the fuels' heating value and the moles of fuel per mole of effluent. The procedure for calculating emission rates may be greatly simplified using the L Factor, which also results in increased accuracy.

By solving for F_{c} in Eq.(91) and then substituting into the conventional emission rate equation, see Lang & Bushey's Eq.(2-2), the following is developed:

ER₁=L_{Fuel} Ξ_{AF} φ_{Dry-1} N₁/ [100 N_{DryGas]} (104)

where φ_{Dry-1} is the dry-base molar concentration of species i (in per cent), N₁ is the species' molecular weight, and N_{DryGas} is the molecular weight of the dry total effluents. As an example, for SO₂ effluent using the nomenclature of '711, see Eq.(29) of '711: φ_{Dry-SO2}=k.

For any effluent measured on a wet-base (φ_{Wet-1}):

ER₁=L_{Fuel} Ξ_{AF} φ_{Wet-1} N₁/ [100 N_{WetGas} (1−WF_{H2O})] (105)

The preferred embodiment is to use Eq.(104) which involves less uncertainty given possible inaccuracies in determining WF_{H2O}, discussed above. The factor Ξ_{AF} is defined by Eq.(84). The factor Ξ_{On-L} may be substituted for Ξ_{AF} in Eqs.(104) and (105) as taught in Eqs.(97) and (98).

The accuracy of using the L Factor for computing emission rates is demonstrated by the L Factor's ability to match measured unit heat rates (see above table). The L Factor may track operational changes, whereas the F Factor requires numerical bias or contrived correlations. As reported by Lang & Bushey, errors in emission rates based on the F Factor may exceed 10% for certain fuels, with common errors of 3%. The preferred embodiment of this invention when determining emission rates is to use the L Factor as taught by Eqs. (104) & (105), replacing EPA methods.

### THE DRAWINGS

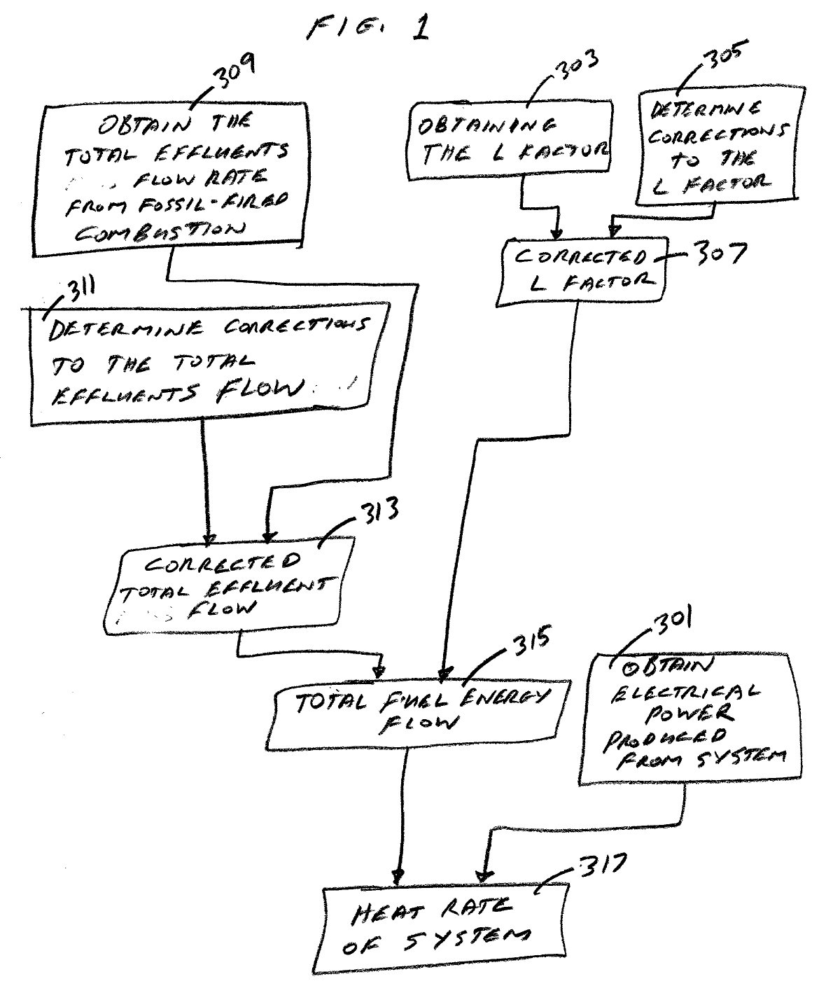

FIG. 1 illustrates an important portion of this invention, the determination of unit heat rate associated with a fossil fueled power plant. Box 301 depicts the measurement of electrical generation produced by the thermal system. Box 303 depicts the calculation of the L Factor defined by Eqs.(72A) or (75A), or otherwise determined as discussed herein, including the use of Eq.(91) if applicable. Box 305 depicts the calculation of the factors Ξ_{AF} or Ξ_{On-L} defined by Eqs.(84), (97) or (98), or otherwise determined as discussed herein, including Ξ_{AF/Wet}. Box 307 depicts the multiplication of the L Factor by the correction to the L Factor. Box 309 depicts the measurement of the total effluents flow from fossil combustion. Box 311 depicts the determination of a correction factor to the measured total effluents flow, termed φ_{Gas}, and its consistent use with either a mass or volume total effluents flow measurement. Box 313 depicts the multiplication of the measured total effluents flow by its correction factor. Box 315 depicts the calculation of the system's total fuel energy flow as taught, for example, through Eqs.(81), (88), and as discussed following (92A), (92B) & (92C). Box 317 depicts the calculation of the heat rate of the system as taught, for example, thought Eqs.(83), (90), (99) and (100).

For FIG. 1 and elsewhere herein, if used, the words “obtained”, “obtaining”, “determined”, “determining” or “determination” are defined as measuring, calculating, assuming, estimating or gathering from a data base. The word “total effluents” is used to mean all products resultant from the combustion of fossil fuel as found at the point where the flow rate of these combustion products is obtained, for example all effluents exiting from the smoke stack, the smoke stack being the point of flow measurement. The word “effluent” refers to a single, unique, combustion product at the point where the flow rate of all combustion products is obtained, for example CO₂ found in the smoke stack. Further, the words “theoretical combustion” refers to the combustion of fossil fuel with just enough oxygen that none is found in the products of combustion, and such that no pollutants are found in the products of combustion (e.g., CO, NO, SO₃), and, essentially only CO₂, H₂O, SO₂ and N₂ are found in the combustion products, and that the combustion air has no moisture. The words “theoretical combustion” and “stoichiometric combustion” mean the same. The words “adjust” or adjusting” means to correct to a determined value. The words “reasonable agreement” mean that two parameters which are being compared, agree in their numerical values within a determined range or per cent.

What is claimed is:

1. A method for quantifying the operation of a fossil-fired system, the method comprising the steps of:
obtaining an L Factor;
determining a correction to the L Factor which converts its applicability from theoretical combustion to combustion associated with the fossil-fired system, and if applicable the correction for the system heating value base, and if applicable conversion to a wet-base L Factor;
combining the L Factor and the correction to the L Factor, resulting in a corrected L Factor;
obtaining a total effluents mass flow rate from the fossil-fired;
obtaining a correction factor for the total effluents mass flow rate, resulting in a corrected total effluents mass flow rate; and
dividing the corrected total effluents mass flow rate by the corrected L Factor, resulting in a total fuel energy flow of the system.

2. The method of claim 1, wherein the step of obtaining the total effluents mass flow rate includes the steps of:
obtaining a total effluents volumetric flow rate from the fossil-fired system;
obtaining a density of the total effluents; and
obtaining the total effluents mass flow rate by multiplying the total effluents volumetric flow rate by the density of the total effluents.

3. The method of claim 1, including additional steps, after the step of dividing, of:
obtaining a produced electrical power from the fossil-fired system; and
dividing the total fuel energy flow of the system by the produced electrical power, resulting in a heat rate of the fossil-fired system.

4. The method of claim 1, including additional steps, after the step of dividing, of:
obtaining a fuel heating value of the fuel consumed by the fossil-fired system; and
dividing the total fuel energy flow of the system by the fuel heating value, resulting in a fuel flow rate of the fossil-fired system.

5. The method of claim 4, including additional steps, after the step of dividing, of:
obtaining a turbine cycle energy flow;
obtaining a boiler efficiency;
obtaining a turbine cycle based fuel flow rate by dividing the turbine cycle energy flow by the product of the boiler efficiency and the fuel heating value; and
adjusting the turbine cycle energy flow until the turbine cycle based fuel flow rate and the fuel flow rate are in reasonable agreement.

6. The method of claim 1, including additional steps, after the step of dividing, of:
obtaining a fuel flow rate of the fossil-fired system; and
dividing the total fuel energy flow of the system, by the fuel flow rate, resulting in the fuel heating value of the fuel consumed by the fossil-fired system.

7. The method of claim 6, including additional steps, after the step of dividing, of:
obtaining a turbine cycle energy flow;
obtaining a boiler efficiency;
obtaining a turbine cycle based fuel heating value by dividing the turbine cycle energy flow by the product of the boiler efficiency and the fuel flow rate; and
adjusting the turbine cycle energy flow until the turbine cycle based fuel heating value and the fuel heating value are in reasonable agreement.

8. A method for quantifying the operation of a fossil-fired system, the method comprising the steps of:
obtaining a L Factor;
determining a correction to the L Factor which converts its applicability from theoretical combustion to combustion associated with the fossil-fired system, and if applicable the correction for the system heating value base, and if applicable conversion to a wet-base L Factor;
combining the L Factor and the correction to the L Factor, resulting in a corrected L Factor;
obtaining a concentration and molecular weight of an effluent from fossil combustion associated with the fossil-fired system;
obtaining an average molecular weight of the total effluents;
dividing the product of the corrected L Factor, the effluent concentration and the effluent molecular weight, by the average molecular weight of the total effluents, resulting in an emission rate of the effluent.

9. A method for quantifying the operation of a fossil-fired system, the method comprising the steps of:
obtaining a concentration of the effluent CO₂ found in combustion products from the fossil-fired system;
obtaining a total effluents volumetric flow rate from the fossil-fired system;
obtaining a correction factor for the total effluents volumetric flow rate, resulting in a corrected total effluents flow rate;
obtaining an F_{c} Factor; and
dividing the product of the corrected total effluents flow rate and the concentration of effluent CO₂ by the F_{c} Factor, resulting in a total fuel energy flow of the system.

10. The method of claim 9, wherein the steps of obtaining the total effluents volumetric flow rate and obtaining the correction factor for the total effluents volumetric flow rate, includes the steps of:
obtaining a total effluents mass flow rate from the fossil-fired system;
obtaining a correction factor for the total effluents mass flow rate;
obtaining a density of the total effluents; and
obtaining the corrected total effluents flow rate by combining the correction factor for the total effluents mass flow rate with the total effluents mass flow rate, and dividing by the density of the total effluents.

11. The method of claim 9, wherein the steps of obtaining the total effluents volumetric flow rate and obtaining the correction factor for the total effluents volumetric flow rate, includes the steps of:
obtaining a total effluents mass flow rate from the fossil-fired system;
obtaining a correction factor for the total effluents mass flow rate;
obtaining a conversion from volume to moles;
obtaining an average molecular weight of the total effluents; and
obtaining the corrected total effluents flow rate by combining the total effluents mass flow rate, the correction factor for the total effluents mass flow rate, and the conversion from volume to moles, and then dividing by the average molecular weight of the total effluents.

12. The method of claim 9, including additional steps, after the step of dividing, of:
obtaining a produced electrical power from the fossil-fired system; and
dividing the total fuel energy flow of the system by the produced electrical power, resulting in a heat rate of the fossil-fired system.

13. The method of claim 9, including additional steps, after the step of dividing, of:
obtaining a fuel heating value of the fuel consumed by the fossil-fired system; and
dividing the total fuel energy flow of the system by the fuel heating value, resulting in a fuel flow rate of the fossil-fired system.

14. The method of claim 13, including additional steps, after the step of dividing, of:
obtaining a turbine cycle energy flow;
obtaining a boiler efficiency;
obtaining a turbine cycle based fuel flow rate by dividing the turbine cycle energy flow by the product of the boiler efficiency and the fuel heating value; and
adjusting the turbine cycle energy flow until the turbine cycle based fuel flow rate and the fuel flow rate are in reasonable agreement.

15. The method of claim 9, including additional steps, after the step of dividing, of:
obtaining a fuel flow rate of the fossil-fired system; and
dividing the total fuel energy flow of the system by the fuel flow rate, resulting in the fuel heating value of the fuel consumed by the fossil-fired system.

16. The method of claim 15, including additional steps, after the step of dividing, of:
obtaining a turbine cycle energy flow;
obtaining a boiler efficiency;
obtaining a turbine cycle based fuel heating value by dividing the turbine cycle energy flow by the product of the boiler efficiency and the fuel flow rate; and
adjusting the turbine cycle energy flow until the turbine cycle based fuel heating value and the fuel heating value are in reasonable agreement.

17. The method of claim 1, wherein the step of determining the correction to the L Factor is replaced with the steps of:
obtaining a combustion air flow rate of the fossil-fired system by on-line monitoring;
obtaining a fuel flow rate of the fossil-fired system by on-line monitoring;
determining a correction for the system heating value base used by the fossil-fired system;
determining an on-line correction to the L Factor by combining the combustion air flow rate, the fuel flow rate and, if applicable, the correction for the system heating value base; and
combining the L Factor and the on-line correction to the L Factor, resulting in the corrected L Factor.

18. The method of claim 8, wherein the step of determining the correction to the L Factor is replaced with the steps of:
obtaining a combustion air flow rate of the fossil-fired system by on-line monitoring;
obtaining a fuel flow rate of the fossil-fired system by on-line monitoring;
determining a correction for the system heating value base used by the fossil-fired system;
determining an on-line correction to the L Factor by combining the combustion air flow rate, the fuel flow rate and, if applicable, the correction for the system heating value base; and
combining the L Factor and the on-line correction to the L Factor, resulting in the corrected L Factor.

19. The method of claim 1, wherein the step of obtaining the L Factor, includes the step of:
obtaining a concentration of the effluent CO₂ found in combustion products from the fossil-fired system;
determining the correction to the L Factor which converts its applicability from theoretical combustion to combustion associated with the fossil-fired system, and if applicable the correction for the system heating value base, and if applicable conversion to a wet-base L Factor;
obtaining an average molecular weight of the total effluents;
obtaining a conversion from volume to moles;
obtaining an F_{c} Factor; and
dividing the product of the average molecular weight of the total effluents and the F_{c} Factor by the product of concentration of the effluent CO₂, the conversion from volume to moles and the correction to the L Factor, resulting in the L Factor.
